(19) United States
(12) Patent Application Publication
(10) Pub. No.: US 2019/0370802 A1
(43) Pub. Date: Dec. 5, 2019

(54) PAYMENT INTERMEDIARY DEVICE USING DELEGATE TOKENIZATION

(71) Applicant: Enpulz, LLC, Austin, TX (US)

(72) Inventors: James Duane Bennett, Hroznetin (CZ); Bindu Rama Rao, Laguna Niguel, CA (US)

(73) Assignee: Enpulz, LLC, Austin, TX (US)

(21) Appl. No.: 15/997,977

(22) Filed: Jun. 5, 2018

(51) Int. Cl. G06Q 20/38; G06Q 20/02; G06Q 20/16; G06Q 20/32

(52) U.S. Cl. CPC G06Q 20/38215; G06Q 20/02; G06Q 20/3227; G06Q 20/3224; G06Q 20/16

(57) ABSTRACT

A secure payment infrastructure supporting delegate tokenization to carry out purchase transactions with a merchant website or point of sale terminal. A payer empowers a delegate to buy products from a merchant system on his behalf by provisioning the delegate with a delegate token and cryptogram. The payer's payment device hardware is bifurcated into a secure circuitry and a non-secure circuitry wherein the keys, tokens, cryptograms used in delegate tokenization, and software application controlling the delegate token-based purchase transactions are stored in the secure circuitry.

### BACKGROUND

### 1. Technical Field

The present invention relates generally to secure financial transactions, and, more specifically, to mobile device-based sales transactions and fund transfers by a customer using cards, mobile devices and computers with merchant web sites and point of sale terminals based on account tokenization.

### 2. Related Art

Several types of bank cards and credit cards exist today that people use for purchasing goods and services, online and at stores. With some of these cards, card information can be stored in the phone and exchanged with a merchant terminal to carry out a transaction. In others, tokens that represent card information can be stored instead of the actual card information. Interfacing with a merchant system may be based on contact, tethered, near contact (short range wireless), or via Internet connectivity. Mobile devices such as phones and even cards can be designed and configured to interface in any one or more of such ways.

Token use offers security as they do not reveal the underlying account information. Moreover, for added security, tokens can carry many types of usage restrictions. For example, it may only be used with the current merchant, have a one-time use, or be valid only for a week. Tokens are passed by a user's card, computer, or mobile device through a merchant system toward an issuer's system for processing. The issuer's system uses the token to securely access the account information via database look up. For example, mobile wallet solutions such as Apple Pay and Google Wallet use this kind of tokenization.

To carry out secure tokenization, secure elements are located in secure hardware (such as within Near Field Communication or NFC circuitry) associated with a card, mobile device or computer or in a cloud-based support service or on some other particular supporting server. For example, a secure element is often employed inside an NFC based credit card, or within a mobile device, that stores token information, that can be shared with merchant terminals during sales transactions. The secure element (SE) within a mobile device provides a tamper-proof environment that supports a customer interaction with and through a merchant system to carry out an end to end secure payment transaction wherein moneys are moved between the customer's credit card or bank account to an account of the merchant.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a block diagram illustrating one possible embodiment of a payment infrastructure supporting delegate tokenization to carry out purchase transactions in accordance with the present invention;

FIG. 2a is a block diagram illustrating a plurality of hardware units present in a user payment device that supports both direct token-based purchasing on behalf of the device owner and delegate token-based purchasing on behalf of a third party in accordance with the present invention;

FIG. 2b is a block diagram illustrating a plurality of hardware units present in another possible embodiment of a user payment device that is an NFC enabled device, and is involved in a delegate-based sales transaction in accordance with the present invention;

FIG. 2c is a block diagram illustrating a plurality of hardware units of yet another possible embodiment of a user payment device that does not have a battery, and is involved in a delegate-based sales transaction in accordance with the present invention;

FIG. 3 is block diagram illustrating a plurality of systems, devices, hardware units and software that cause a delegate-based sales transaction to happen either with a merchant POS or online in accordance with the present invention;

FIG. 4a illustrates flow of data and command between a plurality of devices and systems during a delegate-based sales transaction with a merchant web site or a merchant point of sale terminal, wherein a payer's payment device generates a cryptogram necessary for the delegate-based sales transaction in accordance with the present invention;

FIG. 4b illustrates flow of data and command between a plurality of devices and systems during a delegate-based sales transaction with a merchant web site or a merchant point of sale terminal, wherein a delegate's payment device generates a cryptogram necessary for the delegate-based sales transaction in accordance with the present invention;

FIG. 4c illustrates flow of data and command between a plurality of devices and systems during a delegate-based sales transaction with a merchant web site or a merchant point of sale terminal, wherein a delegate's payment device generates a cryptogram necessary for the delegate-based sales transaction based on a delegate key generated by a payer's payment device in accordance with the present invention;

FIG. 5 illustrates flow of challenges between a plurality of devices and systems during a delegate-based sales transaction wherein a delegate performs the sales transaction with a merchant POS or a merchant web site on behalf of a payer in accordance with the present invention; and

FIG. 6 is a perspective block diagram of a plurality of circuitry involved in a delegate-based sales transaction with a merchant web site or a merchant point of sale terminal.

### DETAILED DESCRIPTION OF THE DRAWINGS

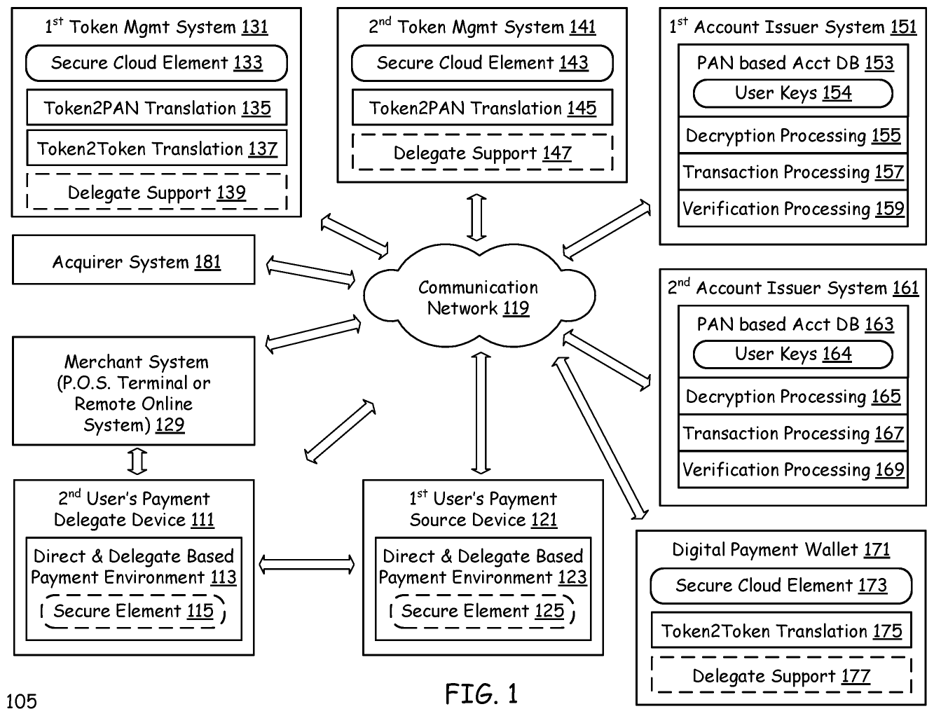

FIG. 1 is a block diagram illustrating one possible embodiment of a payment infrastructure supporting delegate tokenization to carry out purchase transactions in accordance with the present invention. In a token-based sales transaction system 105, a first user (i.e., a buyer or customer) using a first user payment source device 121 purchases a plurality of products and/or services with a merchant system 129 via a second user (i.e., a delegate) using a second user's payment delegate device 111. The second user payment delegate device 111 uses a delegate token delivered to it by or on behalf of the first user payment source device 121 to conduct the sales transaction with the merchant system 129.

A first token management system 131 generates a first direct token for sales transaction to be conducted by the first user by using PAN (Primary Account Number) of the first user's credit or debit card and delivers the first direct token to the first user's payment source device 121 via a communication network 119. The first token management system 131 stores the first direct token and the PAN of the first user in a token vault. The first token management system 131 receives the PAN of the first user from a first account issuer system 151 that has issued a credit and/or a debit card to the first user. Once the first user chooses a list of products and/or services to be purchased from the merchant system 129, the first user's payment source device 121 generates a first cryptogram that is unique to the current sales transaction and sends the first direct token and the first cryptogram to the merchant system 129 via the communication network 119. The first user's payment source device 121 stores the first direct token and the first cryptogram in a secure element 125. In another operating mode, the first direct token and the first cryptogram are stored in a cloud based secure element 143 which is maintained by the first token management system 131. The first direct token may be one or more of the following kind; a limited use token, a channel specific token, for example, valid only for NFC based communication between the first user's payment source device 121 and the merchant system 129, a merchant-specific token. An acquirer system 181 processes a sales transaction by receiving transaction data from the merchant system 129 and then communicating with the appropriate financial institutions, such as token management systems 131, 141 to approve or decline transactions. The acquirer system 181 is also able to settle completed transactions through financial institutions, such as account issuer systems 151, 161, in order to deposit funds into the merchant's bank account. The merchant system 129 sends the first direct token and the first cryptogram to the acquirer system 181 which in turn sends this information to the first token management system 131. The first token management system retrieves the PAN of the first user by passing the first direct token through a token2PAN translation 145 and communicates the PAN of the user and the first cryptogram to the first account issuer system 151 for authorization. The first account issuer system 151 decodes the first cryptogram to learn about the current sales transaction, and either authorizes or rejects the current sales transaction. In another operating mode, the first account issuer system 151 issues a challenge to the first user's payment source device 121 and rejects or authorizes the current sales transaction based on outcome of the challenge. The challenge includes one or more of the following; user identification using biometrics, PIN, payment device identification using device profile. Once authorized by the first account issuer system 151, the first token management system 131 communicates an appropriate “transaction authorized” message to the merchant system 129 via the acquirer system 181. The merchant system 129 delivers the purchased products and/or services to the first user's payment source device 121. Other variations of information flow between these various entities are also contemplated.

Depending on the configuration, the first user intends to purchase a plurality of products and/or services from the merchant system 129 via the second user using the second user's payment delegate device 111. The first user agrees upon a list of products and/or services to be purchased from the merchant system 129 via the second user's payment delegate device 111 via a video and/or audio real time participation using a camera, a microphone and and/or a speaker on the second user's payment delegate device 111. Once agreed, the first user's payment source device 121 initiates delivery of a delegate token and a second cryptogram that is specific to the agreed upon sales transaction to the second user's payment delegate device 111. The first user's payment source device 121 generates the second cryptogram. The delivery of the delegate token and the second cryptogram to the second user's payment delegate device either happens in advance of or during the delegate-based sales transaction. The delivery may involve either the first user's payment source device 121 making the delivery or in another mode, causing the first token management system 131 to make the delivery. In either case the delegate token is the first direct token that the first user's payment source device 121 uses to conduct direct sales transaction with the merchant system 129. The first user's payment source device 121 stores the second cryptogram in either the secure element 125 or in the cloud secure element 143. During the initiation of delivery, the delivery and the sales transaction, the first user's payment source device 121 can be collocated with the second user's payment delegate device 111 or located remotely. Communication between the first user's payment source device 121 and the second user's payment delegate device 111 may occur directly, in a peer to peer wireless or wired fashion, or indirectly via a communication network 119. The first user's payment source device 121 and the second user's payment delegate device 111 can be any one of a smart credit card, mobile device (such as a phone or tablet), and personal computer.

In another configuration, once the first user agrees upon the sales transaction to be conducted via the second user's payment delegate device 111, the first user's payment source device 121 requests the first token management system 131 to provide it with a delegate token. The first user's payment source device 121 may request the first token management system 131 to put one or more of the following restrictions on the delegate token while issuing; type of products and/or services to be purchased, merchant specific, maximum value of transaction, maximum number of transactions, validity for a period of time. The first token management system 131 generates and delivers the delegate token with or without restrictions to the second user's payment delegate device 111 either via the first user's payment source device 121 or via the communication network 119. In this configuration the first user's payment source device 121 initiates delivery of the second cryptogram generated by it to the second user's payment delegate device 111. The delegate token which is separate from the first direct token associated with the first user is stored in the secure cloud element 143.

The second user's payment delegate device 111 initiates sales transaction with the merchant system 129 using the delegate token and the second cryptogram. The merchant system 129 sends the delegate token and the second cryptogram to the first token management system 131 via the acquirer system 181. The first token management system 131 passes the delegate token through the token2PAN translation 145 and identifies that the delegate token is associated with the PAN of the first user. The first token management system 131 sends the PAN of the first user and the second cryptogram to the first account issuer system 151. The first account issuer system 151 decodes the second cryptogram to learn about the delegate-based sales transaction that the second user's payment delegate device 111 conducted on behalf of the first user and either authorizes or rejects the delegate-based sales transaction. The decision of the first account issuer system 151 to approve of the delegate-based sales transaction may depend on verification of one or more of the following; first user and/or second user identification using biometrics, PIN, second user's payment device identification using device profile. Once authorized by the first account issuer system 151, the first token management system 131 communicates an appropriate “transaction authorized” message to the merchant system 129 via the acquirer system 181. The merchant system 129 delivers the purchased products and/or services to the second user's payment delegate device 111. Other variations of information flow between these various entities are also contemplated.

In yet another configuration, the first token management system 131 generates separate delegate tokens for separate delegate-based sales transactions conducted by the first user. All of the separate delegate transactions may involve the second user's payment delegate device 111 or different payment devices. The separate delegate tokens generated by the first token management system 131, in another configuration, is payment device-specific, i.e., one each for a separate payment device. In another configuration, the second user's payment delegate device 111 generates the second cryptogram corresponding to a delegate-based sales transaction agreed upon between the first user and the second user. In this configuration, the first user's payment source device 121 sends a key to the second user's payment delegate device 111. The second user's payment delegate device 111 uses the key to generate the second cryptogram and stores the second cryptogram in a secure element 115 inside the second user's payment delegate device 111. The second user's payment delegate device 111 sends the delegate key and the second cryptogram to the merchant system 129 to complete the delegate-based sales transaction. The merchant system 129 communicates with the second user's payment delegate device using near filed communication (NFC). This communication can be any wired or wireless linkage such as contact or near contact or remote communication. The merchant system 129 sends the delegate key and the second cryptogram to the acquirer system 181 which in turn forwards these data to the first token management system 131. The first token management system 131 uses the token2PAN translation to identify that the delegate key is associated with the first user's PAN and sends the first user's PAN and the second cryptogram to the first account issuer system 151. The first account issuer system 151 decodes the second cryptogram to learn about the delegate-based sales transaction and sends challenges to the first user's payment source device 121 and/or to the second user's payment delegate device 111 before authorizing the delegate-based sales transaction. The first account issuer system 151 may or may not be aware of the fact that the second cryptogram was generated by the second user's payment delegate device 111. The authorization process conducted by the first account issuer system 151 between it and the first and/or the second user involves one or more of user authentication using photo, biometrics, PIN, device identification using device profile, merchant identification, and transaction amount validation. The above authorization process may be triggered or heightened depending on the amount of the sales transaction.

In another configuration the second user's payment delegate device 111 is associated with a second token management system 141. The second user's payment delegate device 111 conducts direct sales transaction with merchant system 129 using a second direct token generated by the second token management system 141 and delivered to it via the communication network 119. The second direct token is stored in the token vault (PAN2Token) and in the secure element 115. The delegate token that is generated by the first token management system 131, for use during delegate-based sales transaction conducted by the second user's payment delegate device 111 on behalf of the first user, is sent to the second token management system 141 wherein 141 stores the delegate token in cloud secure element 143. Alternatively, the first token management system 131 chooses to send the delegate token to a digital payment wallet 171 wherein the digital payment wallet 171 stores the delegate token in another secure cloud element 173. The second user's payment delegate device 111 triggers an online delegate-based sales transaction with the merchant system 129 which is at a remote location. The second user's payment delegate device downloads an HCE (host card emulator) received from the first token management system 131 and also receives the delegate token from wherever it is, either the secure cloud element 133, or the secure cloud element 143, or the secure cloud element 173. The first token management system 131 coordinates with the second token management system 141 and/or the digital payment wallet 171 to get the delegate token delivered to the second user's payment delegate device 111. In this configuration the second user's payment delegate device 111 does not receive the delegate key from the first user's payment source device 121. Other variations of information flow between these various entities are also contemplated.

Similarly, in another embodiment, a first cellular phone 111, of a first person, supports a purchase transaction involving a merchant terminal 129 of a merchant and a payment processing infrastructure. The purchase transaction occurs while the merchant terminal 129 and the first cellular phone 111 are collocated at a first premises (for example, a store). The first cellular phone 111 comprises a first communication circuitry 255 configured to couple via cellular telephony networks to a second cellular phone 121 of a second person, the second person being a buyer, the first person being independent of the merchant and assisting the buyer in the purchase transaction (even if the first person is at the merchant premises). The first cellular phone 111 also comprises a second communication circuitry 257 configured to couple with the merchant terminal 129 and a processing circuitry 211 configured to securely manage the purchase transaction carried out between the second cellular phone 121 and the merchant terminal 129 based on token and cryptogram exchanges via the first communication circuitry 255 and the second communication circuitry 257, while the second cellular phone 121 is at a location remote from the first premises.

The present invention, in one embodiment, employs cryptograms for securely communicating transaction data during card-based transactions so that advertisements can be presented to the buyer based on the transaction data. This may involve, depending on the implementation, a secure element in one or both of the buyer and buyer assistant's (i.e., delegates) computing or phone devices. A card-based transaction (which herein extents to payment transactions involving debit, credit, bank account and cryptocurrency holdings) may involve the phone device 161 utilizing encryption using a public/private key pairing for secure communications. The private key may be made available in the secure element of the remote phone that is provided by a remote buyer, for example. The public key is held in cross reference to the PAN and is only known by the issuer of the associated card (credit card, debit card, etc.). So, the first token management system 131 (for example), or a TCCM (Token & Customer Contact Management) infrastructure that works with an account issuer system helps the issuer by masking the PAN with a token, via a token vault provided.

In one approach, a remote cellular phone exchanges a first category of transaction data with the local cellular phone in naked (unencrypted) form via an encrypted or unencrypted internet pathway, e.g., employing typical communication layer security/encryption such as SSL. Such transaction data can be communicated before during or after a current sales transaction. A second category of transaction data is exchanged using an encryption approach and pairing established via key exchanges between the remote and the local phones. Such second category data is intended to be locked by the sender and unlocked by the receiver, wherein the sender and receiver are the remote and local phones in a full duplex communication exchange. A third category of transaction data involves a secure element in at least one of the remote and local phones wherein the one or both secure elements are used to establish cryptograms by one of the remote and local phones that may be destined for decryption by the other of the local or remote phones or by the merchant system, TCCM, or, more likely, the issuer system. Such decryption, like the underlying encryption, involving a secure element. The transaction data category selection depends at least in part on the content needed to be exchanged. Higher categories are more secure than lower categories, so a lower category may be sufficient for a purchase item description, quantity or price, while a higher category for passwords, buyer information, account information and so on.

For example, to service the third category, a remote cellular phone with a secure element can encrypt to create or decrypt to reveal cryptogram content that is destined for a secure element of a merchant system, a local cellular phone of the assistant, the TCCM and the card issuer. Many such cryptograms can be created as needed and delivered through any communication pathway to the final recipient without worrying about intercepting security issues. Similarly, for example, a local cellular phone device in proximity with the merchant system can receive both first and second categories of transaction data, decode the second category, select all or parts of both the category data, apply third level treatment (cryptogram encryption using its secure element), and forwarding the resultant cryptogram to any other node in the transaction flow, e.g., the remote phone, TCCM, merchant system and issuer system.

To support secure elements which each operate via one or more private keys, corresponding public keys must be delivered to other nodes in the transaction flow that will be creating cryptograms. For example, the buyer's phone is configured with a buyer's secure element that may be carried out in hardware, software or in any combination of the two. Such secure element may be configured with all or many of a first private key for issuer interaction, second private key for assistant device interaction, third private key for TCCM interaction, and a fourth private key for merchant system interaction. For the first private key, a public key is held by the issuer system. For the second private key, a public key counterpart is held by assistant device, and counterpart public keys are also held by the TCCM and merchant system for the third and fourth private keys. In this way, for example, the issuer system using the stored first public key can create a cryptogram that only the buyer's phone can decrypt. Likewise, using the stored third public key, the assistant's device might create a cryptogram for decryption by the buyer's phone only and so on. All such cryptogram creation and decryption being managed in secure elements within the sending and receiving devices.

Moreover, each other node in the transaction infrastructure may have its own set of private keys stored in its secure element and have public key counterparts stored in all other transaction infrastructure nodes. For example, both the remote and local phones might have secure elements that store private keys while the issuer system stores a first public key for the remote phone and a second public key for the local phone.

Some transaction flows may require the decryption of a received first cryptogram on one node of the transaction infrastructure before re-encryption into a second cryptogram for delivery to another node in the infrastructure. For example, an issuer system (which may comprise even a cryptocurrency holdings system in some embodiments), may create a cryptogram using a remote phone's first public key corresponding to the remote phone's secure element storage of a first private key. Upon receipt of a cryptogram prepared by the issuer system using the first public key for decryption by the remote phone using the first private key, the remote phone may repackage all or part of the decrypted cryptogram data along with perhaps other local data before using a second public key corresponding to a second private key stored in a secure element of the local phone. Then, the remote phone forwards the new cryptogram to the local phone for decryption using the second private key. All other key pairings between all nodes in full duplex fashion may occur, depending on the needed transaction processing flow.

In another related embodiment, two cellular phones are used by two people to carry out a purchase transaction via a merchant terminal and payment processing infrastructure. During the transaction, the first person visits a merchant while the second person being at a remote location. While collocated with the merchant terminal, the local cellular phone, used by the first person, initiates the purchase transaction on behalf of the remote person, the buyer. Although possible, the local person is typically not affiliated with the merchant. They usually operate independently of the merchant to assist the buyer in making the purchase transaction.

For example, the local and remote persons might be family members, such as a daughter at a campus store having her father, located miles away at home, buy her several university supplies. To do so, the daughter may use her local phone to interact with a merchant's POS (Point of Sale) system during check out while interacting with the father's remote phone that is enabled to carry out the father's credit card transaction. In this way, the father may use his phone and credit card to complete the transaction for the daughter where the daughter's local phone handles the local interaction and coupling of the remote father's phone so that the transaction can be completed. This can be completed with or without the merchant's system ever being aware that the real buyer is not local.

In this example, hiding or revealing the father's remote participation as the true purchaser can be selected by the buyer or required by the issuer or merchant. Depending on this selection or requirement, the daughter's local phone, the father's remote phone, the merchant's system and even the transaction processing infrastructure can be adapted to accommodate the selection. The default, of course, being to hide the participation which does not require (but could) a different functionality in the merchant terminal and transaction processing infrastructure than is conventionally performed, e.g., when the daughter completes the transaction locally with her own card and phone pairing and without her father's help as is conventionally handled. With revelation of the father's remote participation, one or more of the merchant's terminal and transaction processing infrastructure (i.e., the TCCM, card issuer's system, etc.) elements could take on an enhanced functionality to support the remote transaction.

For example, instead of always using the communication pathway between the merchant terminal to the father's phone via the daughter's local phone, an alternate pathway through the cellular network, for example, could be used. For example, a card issuer system might directly SMS confirmation codes to the remote phone that need to be made to confirm not only the transaction amount, but also that the transaction is happening remotely via the daughter's phone. Only if confirmation is given will the issuer system finally grant and send an authorization code to the merchant system so that the transaction can be completed.

Likewise, passwords required by a local merchant system might capture any number (not the correct one) by the daughter, but the card issuer may know this is not correct and merely makes a parallel pin code request via the cellular network to the father's phone. Thus, the merchant might not even know the pin code was entered remotely as the incorrect or any pin code required locally would not be required to capture the correct pin code from the daughter. This will assist the father in not having to expose his pin code to even his daughter. Further, the daughter could be required to enter a onetime code into the merchant's system as delivered via the father's remove phone which the father gathers from direct interaction with the issuer's system. In this way, the father can be sure that it is the daughter that completes the transaction and the pin code used is for a one time use only.

If some situations, the local phone may be held by a merchant's employee who helps guide product selection and plans to coordinate shipping or delivery to the remote buyer. For example, a grocery delivery service running as part of a grocery store has a series of store employees that receive calls from buyers at home. An employee may then utilize a buyer assistant App to exchange video and voice interchange with a buyer via a mating buyer App, such as walking through isles showing what is for sale and zooming on items and such. They buyer and employee can then work together to fill a cart. On checkout, the buyer interacts through such buyer App to complete a credit or debit card transaction (or other bank account or cryptocurrency holdings) as if the buyer was present with the buyer's phone. This being accomplished via the employee in the checkout line and the buyer assistant App. In this way, the employee's phone acts as a delegate to the purchase transaction carried out by the remote buyer via the buyer's remote phone. A surcharge for such services could be added along with delivery costs, either independent of or combined with the items being purchased using the merchant system.

In particular, in some embodiments, the local cellular phone is configured with first and second communication circuitry and processing circuitry. The first communication circuitry is configured to couple, for example, via cellular telephony networks to the remote cellular phone. The second communication circuitry is configured to couple locally, via for example NFC (Near Field Communication) or Wi-Fi with the merchant terminal. The processing circuitry is configured to securely manage the purchase transaction carried out between the second cellular phone and the merchant terminal based on token and cryptogram exchanges via the first communication circuitry and the second communication circuitry.

As mentioned above, during the purchase transaction, the processing circuitry may also be configured to enable communication between the first (local) person and the second (remote) person during the purchase transaction. The processing circuitry of the local phone may also be configured to exchange encrypted pin code information between the second cellular phone via the merchant terminal. Such encrypted pin code may be for a one-time use. A onetime use code may also be delivered to the local phone for display to the local person to enable a manual entry of such code into the merchant's system. Similarly, the processing circuitry of the local phone may also be configured to pass token and encryption information to secure at least part of the transaction data from access by the first person. Such encryption may involve transaction cryptograms. Local phone processing circuitry and the remote phone processing circuitry may either or both contain secure elements therein to support such cryptogram-based exchanges, complete with any needed encryption and decryption needed to support a secure purchase transaction.

In yet other implementations, any assisting computing device of a buyer's assistant can be utilized to assist any remote computing device of the remote buyer. Communication circuitry within the assisting and remote computing devices can be configured to couple each such device via a cellular or any other communication network. Even a transaction where the assistant (perhaps a daughter as in the above example) attempts to buy her books online. To do this with her father's help, the daughter interacts through her computing device as an intermediary node to set up the transaction and then interacts via her computing device to her father's computing device (both of which may be cell phones) for payment to be completed by the father using the father's credit card information stored in a secure element on the father's computing device. The daughter's computing device may also contain a secure element that interacts with the father's computing device's secure element to securely carry out the purchase transaction through the merchant system(s) providing the online store experience.

In some configurations, within an assistant's computing device, e.g., a daughter's phone, the processing circuitry supports interaction with the payment processing infrastructure to assist in confirming the purchase transaction. In others, a buyer's computing device, e.g., a father's phone, may also interact with the payment processing infrastructure to so assist. Such interaction may flow through the assistant's computing device and the merchant system and/or flow directly from the buyer's computing device to a particular system (such as an issuer's system or a TCCM) in a payment processing infrastructure. Before, during and after the purchase transaction, the processing circuitry of both the assistant's and buyer's computing devices support communication between the buyer and the assistant in voice, text and/or video exchanges. Such configurations may be built in or may be enabled via downloaded a pairing of Apps on the buyer's and assistant's computing devices.

In another implementation, a support device of a buyer's assistant interacts with a buyer device in carrying out a purchase transaction between the buyer device and a merchant system. The merchant system is coupled to a transaction processing infrastructure, e.g., a TCCM and an issuer system of an issuer. Such interaction involves the support device establishing both a first secure communication flow with the buyer device, and a second secure communication flow with the merchant system. The support device also manages the purchase transaction using a secure element within the support device to attempt to prevent revelation of private transaction information of the buyer or any other node in the transaction infrastructure.

A limited usage element, such as a limited usage password, pin code and/or token are also employed in some configurations. For example, a pin code can be delivered to the buyer's assistant for servicing a pin code capture device of a merchant. Once used and processed by the issuer, it can be disabled. In other words, a onetime usage. Several usage before expiration and not-to-exceed a total amount spent type usage limitations can alternately or additionally be applied. Such pin code may originate with the buyer's computer and its secure element, for example. It can also originate from the TCCM or card issuer. The limited usage may additionally or instead have a limited window of time during which it may be used. It may also require decryption by a secure element within the assistant's support device before it can be applied. Location restrictions can also be applied such as a merchant restriction, a brick and mortar restriction (versus online), or a GPS restriction. Likewise, other types of limited usage elements, such as one time and/or limited window tokens or passwords can also be delivered to the support device for automatic or manual (assistant entry) use via the merchant system(s). It may be normally encrypted (decryption by a non-secure processing circuit element of the support device), unencrypted or encrypted for decryption by a secure processing element within the assistant's support device.

As an example, a remote phone can deliver an authorization code in advance of one or more transaction that expires in 24 hours, cannot be used more than in 3 purchase transactions, total transaction amount must fall within a certain dollar value, and can only be used within 300 feet of a specified GPS address of a shopping mall. Similarly, a token delivered to the buyer's assistant's phone may carry usage limitations specifying a onetime use at a particular merchant in a live transaction only with final confirmation required by an active remote phone of the buyer.

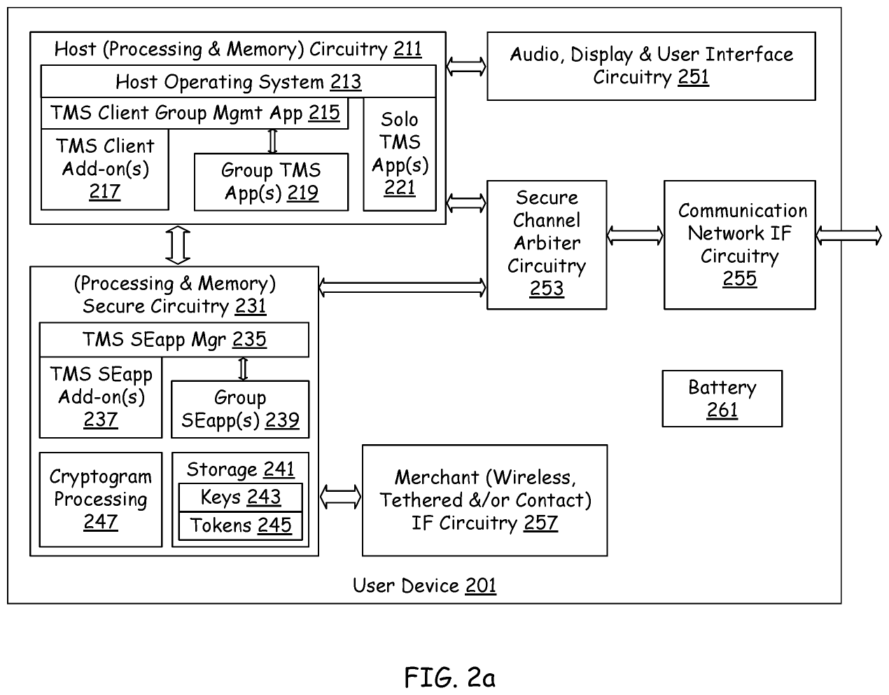

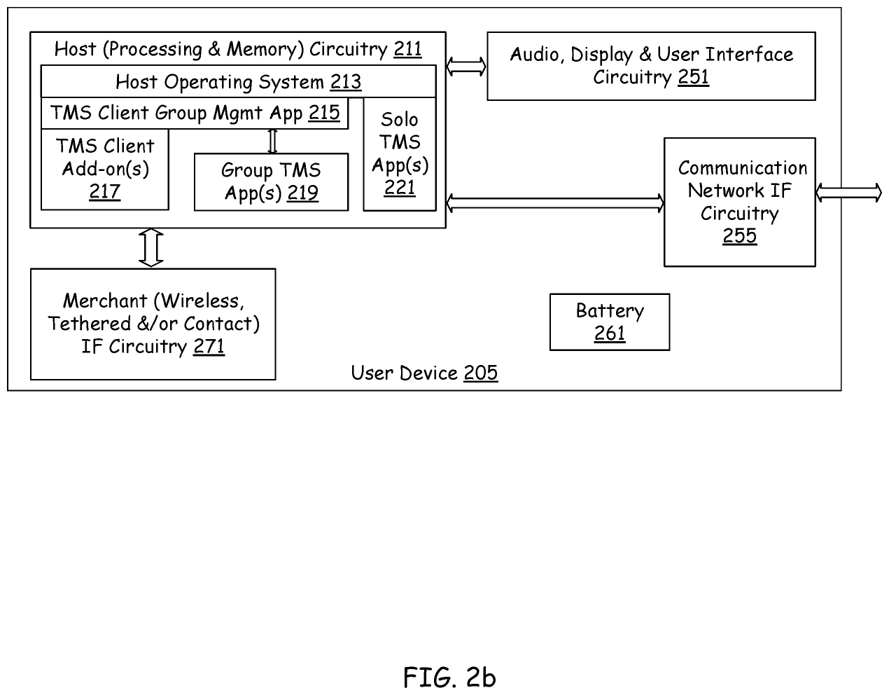

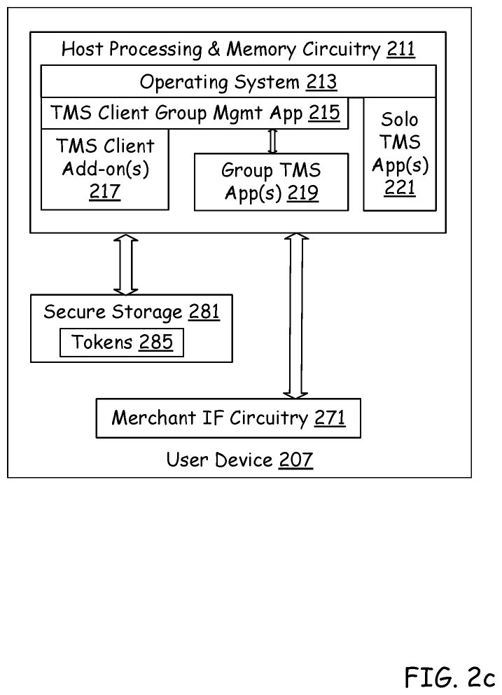

FIG. 2a is a block diagram illustrating a plurality of hardware units present in a user payment device that supports both direct token-based purchasing on behalf of the device owner and delegate token-based purchasing on behalf of a third party in accordance with the present invention. The plurality of hardware units in the user payment device 201 are compartmentalized such that the user payment device 201 uses a merchant interface circuitry 257 for communication with a merchant point of sale and uses a communication network interface circuitry 255 for communication with other data sources either locally or remotely located and/or devices during, for example, but not limited to, Internet browsing, chatting, and Internet based sales transactions. Communication of the user payment device 201 with the merchant point of sale via the merchant interface circuitry 257 can be via one or more of a tethered communication link, a Near Field Communication (NFC) link, and a low power Bluetooth link. Communication of the user payment device 201 with other communication devices using the communication network interface circuitry 255 can be via one or more of a wired link and/or a wireless link. The user payment device 201 is a phone in the present configuration.

The user payment device 201 has a host processing and a memory circuitry 211, and an audio, display and user interface circuitry 251. The host processing and memory circuitry 211 comprises of a host operating system 213. In one configuration of the present invention the user payment device 201 downloads a host card emulation (HCE) that is managed by a token management system (TMS) and runs the HCE on the host operating system 213. TMS client group management applications 215 refers to the HCE in the present configuration. A digital payment wallet like Apply Pay or Google Wallet is running on the host operating system 213 of the user payment device 201 in addition to the HCE. Solo TMS applications 221 refers to the digital payment wallet in the present configuration. The TMS client group management application/s 215 as well as the solo TMS application/s 221 communicate with external data sources and/or devices via a secure channel arbiter circuitry 253 and the communication network interface circuitry 255 using a wireless and/or a wired link. The TMS client application 215 and/or the solo TMS application 221 handles every stage of direct sales transaction between the user payment device 201 and a merchant POS including direct token delivery, cryptogram generation and delivery, user and/or user payment device authentication. The TMS applications 215 and/or 221 handles online (Internet based) direct sales transaction of the user payment device 201 as well.

The user payment device 201 comprises of a secure circuitry 231 that may be a one-time programmable memory and can't be snooped. The secure circuitry 231 comprises of a storage 241 that stores the direct token and keys necessary for cryptogram generation. In a direct sales transaction with the merchant POS, the user device 201 sends the direct token and the cryptogram corresponding to a sales transaction to the merchant POS via the merchant interface circuitry 257, wherein the cryptogram eventually reaches a card issue. The card issuer deciphers the cryptogram and authorizes the sales transaction. The authorization may be preceded by user and/or user device 201 identification and/or verification. Communication between the card issuer and the user device 201 during verification happens via the merchant interface circuitry 257. Verification step involves one or more of a verification by entering PIN, by inputting biometrics, and by providing device profiles. Identification and/or verification step involves interaction of the TMS client App 215 or the solo TMS App 221, as the case may be, with audio, display, and user interface circuitry 251. In an online direct sales transaction conducted by the user device 201, the TMS client App 215 or the solo TMS App 221 causes the direct token and the cryptogram to be delivered to the card issuer from the user device 201 via the communication network interface circuitry 255. The card issuer deciphers the cryptogram and authorizes the online sales transaction, which in some configuration is preceded by user and/or user device 201 credential verification. In an online sales transaction, communication between the card issuer and/or a TMS and the user device 201 during credential verification happens via communication network interface circuitry 255.

The secure circuitry 231 of the user payment phone 201 comprises of a Token Management System Secure Element Application Manager (TMS SEapp Mgr) 235 that manages delegate-based sales transaction with the merchant point of sale (POS) as well as an online delegate-based sales transaction where the user payment device 201 is used by either a payer or a delegate. Communication of the user payment device 201, in either of the paper and the delegate mode of operation, with the merchant POS happens via the merchant interface circuitry 257. In the present configuration the user payment device 201 which here is a phone is used by a payer for the delegate-based sales transaction with a merchant POS. In this configuration the TMS SEapp Mgr 235 initiates delivery of a delegate token to a user payment delegate device, a device that is used by the delegate, either by sending the delegate token directly to the user payment delegate device via the communication network interface circuitry 255 or by getting the delegate token delivered to the user payment delegate device via a token management system and/or a digital payment wallet service. In this payer mode of the user payment device 201, TMS SEapp Mgr 235 arranges to send a cryptogram to the user payment delegate device via the communication network interface circuitry 255 wherein the cryptogram corresponds to a sales transaction to be conducted by the user payment delegate device with the merchant system on behalf of the payer. The cryptogram is generated by a cryptogram processing unit 247 within the secure circuitry 231. The payer may have a plurality of credit cards. In such a case, the TMS SEapp Mgr 235 manages selection of one of the available credit cards for payment or more than one credit card for payment in a shared payment mode by providing a visual selection option to the payer or by performing automatic selection based on selection rules set by the payer in advance. The TMS SEapp Mgr 235 communicates with the audio, display and user interface circuitry 251 to complete the selection of credit card/s, if necessary. The storage 241 inside the secure circuitry 231 is used to store tokens corresponding to the plurality of credit cards and keys used to generate cryptograms, one key each from a credit card issuer. The TMS SEapp Mgr 235 handles communications with the merchant POS via the merchant interface circuitry 257 and communications with user payment delegate device, card issuer systems, and token management systems via the communication network interface circuitry 255. The arbiter 253 gives priority to the TMS SEapp Mgr 235 over the TMS Client App 215 and the Solo TMS App 221 whenever there is a contention for access to the communication network interface circuitry 255 by these applications. The TMS SEapp Mgr 235 is a handset-specific software and/or hardware unit. TMS SEapp Add-ons 237 from the credit card issuer/s and/or the token management system/s are installed and stored inside the secure circuitry 231. The TMS SEapp Mgr 235 handles all stages of the delegate-based sales transaction including delivery of delegate token, optional in-transaction involvement of the payer during product selection, payment and authentication verification challenges from the credit card issuers and/or the token management systems to the payer and/or payer's payment device 201. In another configuration the TMS SEapp Mgr 235 launches a separate control application Group SEapp 239 to handle delegate-based sales transaction. The cryptogram sent from the user payment device 201 to the user payment delegate device is forwarded by the user payment delegate device to the merchant POS. The cryptogram eventually reaches the payer's card issuer. The payer's card issuer deciphers the cryptogram and authorizes the sales transaction. The authorization may be preceded by identification and verification of one or more of the payers, the delegate and the user payment delegate device. Communication between the payer's card issuer and the user payment device 201 during identification and/or verification happens via the communication network interface circuitry 255. Verification step involves one or more of a verification by entering PIN, by inputting biometrics, and by providing device profiles. Identification and/or verification step involves interaction of the TMS SEApp Mgr 235 with audio, display, and user interface circuitry 251.

In yet another configuration of delegate-based sales transaction with the merchant POS, the user payment device 201 is used by a delegate. In this delegate mode of operation, the user payment device 201 receives the delegate token and the cryptogram via the communication network interface circuitry 255 and stores the delegate token and the cryptogram in the storage 241. The user payment device 201 in the delegate mode sends the delegate token and the cryptogram to the merchant POS via the merchant interface circuitry 257. The cryptogram, based on the delegate token eventually reaches the buyer's card issuer. The buyer's card issuer may issue delegate and/or delegate payment device challenge. Such challenges, if issued, reaches user payment device 201, which is used by the delegate in the present configuration, via the merchant POS and the merchant interface circuitry 257. The response to the above challenges is delivered from the user payment device 201 via the merchant interface circuitry 257 as well. The user payment device 201 in the delegate mode communicates with the payer's user payment device via the communication network interface circuitry 255 during product selection for purchase. Such a communication happens either in advance of the sales transaction or during the sales transaction. The TMS SEapp Mgr 235 manages all stages of the delegate-based sales transaction including reception and storage of the delegate token and the cryptogram, sending the delegate token and the cryptogram to the merchant POS, communicating with the payer's user payment device during product selection and communication with the payer's card issuer during authentication and verification of credential of the delegate and the delegate's payment device.

For a POS transaction, the user payment device 201, used by either the payer or the delegate, if goes into “battery down” mode in the middle of a delegate-based sales transaction, gets power from external power source/s via one of the communication network interface circuitry 255, and the merchant interface circuitry 257 using a tethered link. An “offline” user payment device 201 when used in either of the payer or the delegate mode for a POS transaction, participates in the delegate-based sales transaction except that a user and/or device authentication request coming via the communication network interface circuitry 255 is not processed by the offline user payment device 201. The user payment device 201 “offline” during the delegate-based sales transaction also needs to ensure that the delegate token and the cryptogram reaches the delegate's payment device in advance of the sales transaction.

In another configuration the user payment device 201 which is a phone is used by a payer for an online sales transaction. The payer's user device 201 communicates with the delegate's payment device, data sources and/or devices in a cloud, token management systems, and the payer's card issuer via the communication network interface circuitry 255. The user payment device 201 if used by a delegate communicates with the payer's payment device, token management systems and/or devices in the Internet, the payer's card issuer via the communication network interface circuitry 255. For an online sales transaction, the user payment device 201, used by either the payer or the delegate, if goes into “battery down” mode in the middle of a delegate-based sales transaction, gets power from external power source/s via one of the communication network interface circuitry 255 using a tethered link. The user payment device 201 if “offline” cannot participate in online delegate-based sales transaction.

FIG. 2b is a block diagram illustrating a plurality of hardware units present in another possible embodiment of a user payment device that is an NFC enabled device and is involved in a delegate-based sales transaction in accordance with the present invention. The user payment device 205 is for example and without limitation, a phone, a laptop, or an iPad used in a card mode. The plurality of hardware units presents in the user payment device 205 comprises of an audio, display and user interface circuitry 251, a communication network interface circuitry 255, a host processing and memory circuitry 211, a host operating system 213, and a merchant interface circuitry 271. The user payment device 205 communicates with a merchant POS via the merchant interface circuitry 271 using one or more of a tethered communication link, a Near Field Communication (NFC) link, and a low power Bluetooth link, and communicates with other devices and/or data sources such as those in a cloud via the communication network interface circuitry 255. The user payment device 205 has a battery 261. A token management system client application 215 runs on the host operating system 213 of the user payment device 205. In a direct sales transaction with a merchant POS, The TMS Client App 215 initiates delivery of a direct token that corresponds to PAN of a user using the user payment device 205, to the merchant POS. The direct token, which is stored in a cloud storage device is received by the user payment device 205 via the communication network interface circuitry 255 and forwarded by the user payment device 205 to the merchant POS via the merchant interface circuitry 271. The merchant POS in turn forwards the direct token to a token management system that owns the TMS Client App 215. The token management system upon receiving the direct token forwards it to the card issuer. The card issuer asks for identification and verification of user and/or user payment device 205. Communication between the user payment device 205 and the token management system and/or the card issuer during the authentication and verification process takes place via the merchant interface circuitry 271 and the merchant POS. The authentication and verification process involve the audio, display and user interface circuitry 251. In a direct online sales transaction, the TMS Client App 215 is involved in all phases of the sales transaction including delivery of the direct token to an online merchant, user and/or user payment device credential verification by the card issuer. The user payment device 205 in “battery down” mode derives power from external power sources via one of the interface circuitries 271 and 255. An “offline” user payment device is not enabled to participate in a direct sales transaction.

In the present configuration of a delegate-based sales transaction with a merchant POS, the user device 205 is used by a payer. In this payer mode, the user device initiates delivery of a delegate token from a token management network (TMS) that owns the TMS client App 215 or the solo TMS App 221, as the case may be, to a user payment delegate device that is used by a delegate. The delegate token is routed from the token management system to the user payment delegate device either via the user device 205 or not. The delivery of the delegate token to the user payment delegate device occurs during or in advance of the sales transaction. The user payment delegate device conducts the sales transaction with the merchant POS using the delegate token. The card issuer of the payer checks for payer credentials and/or delegate's or user payment delegate device during the sales transaction. Communication between the payer and the card issuer takes place via the communication network interface circuitry 255. For an online transaction the payer's user payment device 205 communicates with the user payment delegate device during product selection and/or delegate token delivery via the communication network interface circuitry 255. The payer's user payment device 205 communicates with the card issuer during payer's credential verification via the communication network interface circuitry 255. In another configuration the user payment device 205 is used by the delegate. The user payment device 205 communicates with the payer via the communication network interface circuitry 255 and with the merchant POS via the merchant interface circuitry 271 using a low power Bluetooth, NFC or a tethered link. In “battery down” mode the user device 205, in either of the delegate or the payer mode, draws power from external power sources via one of the communication network interface circuitry 255 or the merchant interface circuitry 271. If “offline” the user device 205, in either of the delegate or the payer mode, cannot perform sales transaction. However, if the delegate-based sales transaction is with a merchant POS, then an “offline” user payment delegate device is able to complete the sales transaction with the merchant POS if the device is provisioned with the delegate token in advance of the sales transaction.

FIG. 2c is a block diagram illustrating a plurality of hardware units of yet another possible embodiment of a user payment device that does not have a battery and is involved in a delegate-based sales transaction in accordance with the present invention. The plurality of hardware units of the user payment device 207, which is NFC enabled, comprises of a merchant interface circuitry 271, a secure storage 281, and a processing and memory circuitry 281. A TMS Client App 215 runs on an operating system 213. The TMS Client App 215 is for example an HCE that is managed by a token management system. In a configuration, a solo TMS App 221 runs on the operating system 213 as well. The token management system generates a direct token and stores it in the secure storage 281 of the user payment device 207. The user payment device 207 derives power from external power sources via the merchant interface circuitry 271. The user payment device 207 is for example and not limited to a smart card.

In a direct sales transaction with a merchant POS, the user payment device 207 sends the direct token to the merchant POS via the merchant interface circuitry 271. The merchant interface circuitry 271 is at least an NFC interface. The merchant interface circuitry 271 in addition is a low power Bluetooth link, and/or a tethered link. The user payment device 207 participates in an online transaction if the user payment device 207 is in close proximity of a card reader that is communicatively coupled to a PC/phone with Internet connection. The direct sales transaction, whether with a merchant POS or an online transaction, is managed by the TMS Client App 215 and/or the solo TMS App 221, as the case may be.

In a delegate-based sales transaction with a merchant POS, in the present configuration, the user payment device 207 is used by a payer. The payer's device 207 is provisioned with a delegate token in advance of the delegate-based sales transaction. Such provisioning happens in one of the following ways: when the token management system generates the direct token and gets the delegate token stored along with the direct token in the secure storage 281, and the token management system generates the delegate token at a later time and gets it delivered to the user payment device 207 by communicatively coupling to it via the merchant interface circuitry 271. The payer's device 207, in the delegate-based sales transaction delivers the delegate token to the delegate's device, which for example is a phone or a PC or a smart card in advance of the sales transaction. Such delivery of delegate token from the payer's device 207 to the delegate's device is enabled by coupling the payer's device to a card reader via the merchant interface circuitry 271 wherein the card reader is communicatively coupled to the delegate's device. The storage and delivery of the delegate token is managed by the TMS Client App 215.

In another configuration the user payment device 207 is used by the delegate. The delegate's device 207 receives the delegate token from the payer's device which is one of a phone, a PC or a smart card in advance of the sales transaction with the merchant POS. The delegate's payment device 207 performs the sales transaction with the merchant POS via the merchant interface circuitry 271. Restrictions on the delegate token are set by the card issuer of the payer in consultation with the payer. Such restrictions are one or more of, sales transaction amount, merchant specific, product specific, channel specific. The storage of the delegate token and sales transaction with the merchant POS is managed by the TMS Client App 215.

A delegate-based online sales transaction by the user payment device 207 wherein the user payment device is used by a delegate is possible if the delegate's device 207 is provisioned with the delegate token in advance of the sales transaction and the delegate's device is coupled to a card reader that is in turn connected to a phone/laptop/such device with Internet connection.

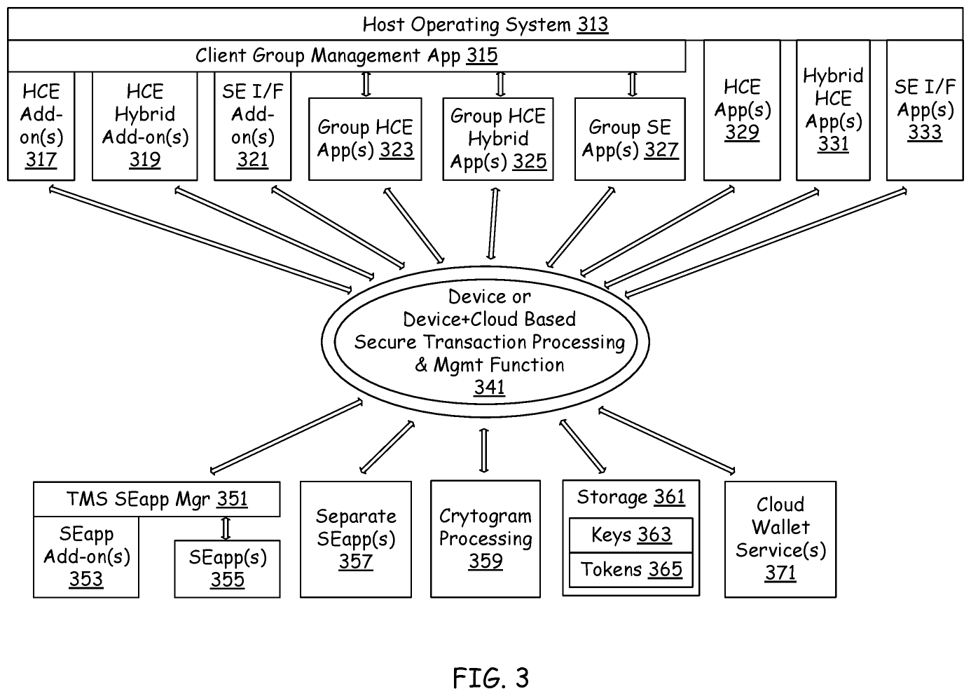

FIG. 3 is block diagram illustrating a plurality of systems, devices, hardware units and software that cause a delegate-based sales transaction to happen either with a merchant POS or online in accordance with the present invention. A payer authenticates a delegate to purchase services and /or goods online and/or from a merchant POS on his behalf. The payer's payment device causes to deliver a delegate token and optionally a cryptogram to the delegate's payment device wherein the delegate's payment device uses the delegate token and the cryptogram, if present, to complete the sales transaction. The sales transaction involves selection of products for purchase by the payer in advance. The sales transaction optionally involves credential verification of the payer, the delegate, and the delegate's payment device. The payer's payment device as well as the delegate's payment device have a plurality of specialized hardware blocks that include, but not limited to, secure storage areas 361 used to store keys 363, and tokens 365, secure circuitry to store applications managing sales transactions such as 351, 353 and 355, cryptogram processing unit 359, separate communication interface circuitry for communication with merchant POS and other networked devices including those in a cloud, and an arbiter to protect the delegate-based sales transaction from fraud. The above-mentioned hardware blocks are accessed by a plurality of software applications, that are running on the operating system of buyer's payment device, on the operating system of the delegate's payment device and/or on devices in a cloud. The software applications include, but not limited to, host applications, and client applications, for example, HCE Apps 329, HCE Add-ons 317, Group SE App 327, and SE I/F App 333. In one configuration the payer's payment device is a smart card and the delegate's payment device is a phone comprising of two separate interface circuitry, one for communication with merchant POS, and another for communication with external data sources and/or devices, a secure circuitry to store a secure storage, a cryptogram processing unit, and a secure SE App that manages all steps of delegate-based sales transaction with a merchant POS as well as online sales transaction. The smart card has an NFC enabled interface circuitry, and a secure storage to store the tokens. In this configuration, the payer's payment device in conjunction with a card reader participates in a delegate-based sales transaction with a merchant POS as well as online.

In a second configuration, the payer's payment device is smart card and the delegate's payment device is PC/phone in card mode comprising of two separate interface circuitry, one for communication with merchant POS, and another for communication with external data sources and/or devices, but without a secure circuitry/storage. Tokens required for direct and/or delegate-based sales transaction are fetched by the delegate's payment device from the cloud.

In a third configuration, the payer's payment device is a PC/phone in card mode and the delegate's payment device is a smart card. The delegate's payment device need to be provisioned with the delegate token in advance of the sales transaction for it to participate in transaction.

In a fourth configuration, the payer's payment device is a PC/phone in card mode and the delegate's payment device is a phone with secure SE App running on it. An HCE client running on the PC/phone in card mode controls involvement of the payer's payment device and the secure SEApp running on the PC/phone in card mode controls involvement of the delegate's payment device in the delegate-based transaction. The delegate-based sales transaction is with a merchant POS and/or online.

In a fifth configuration, the payer's payment device is a phone with secure SEApp running on it and the delegate's payment device is another phone with another secure SEApp running on it.

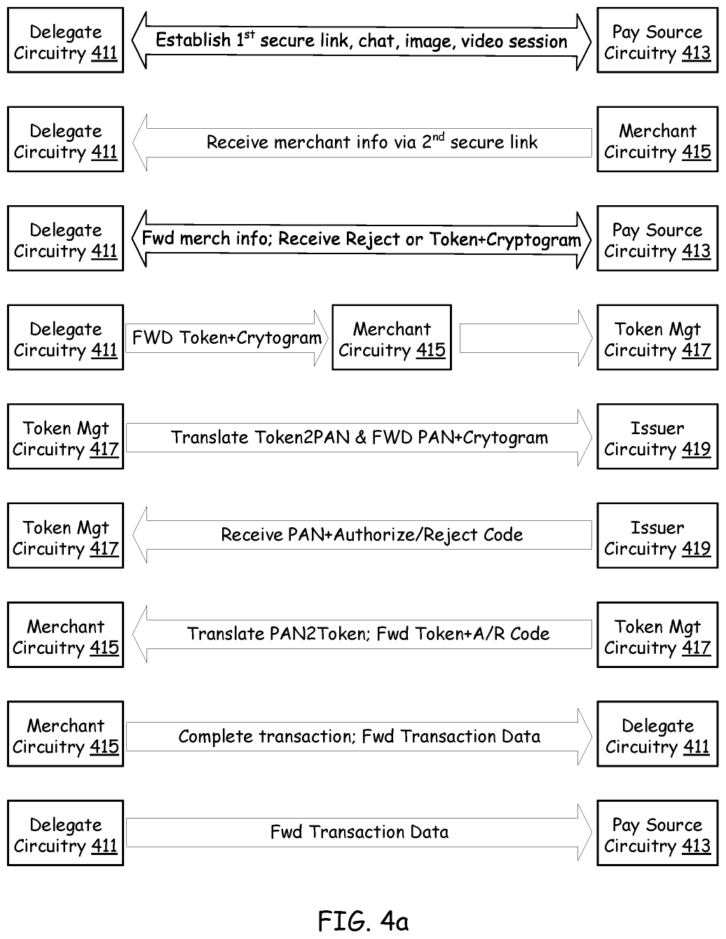

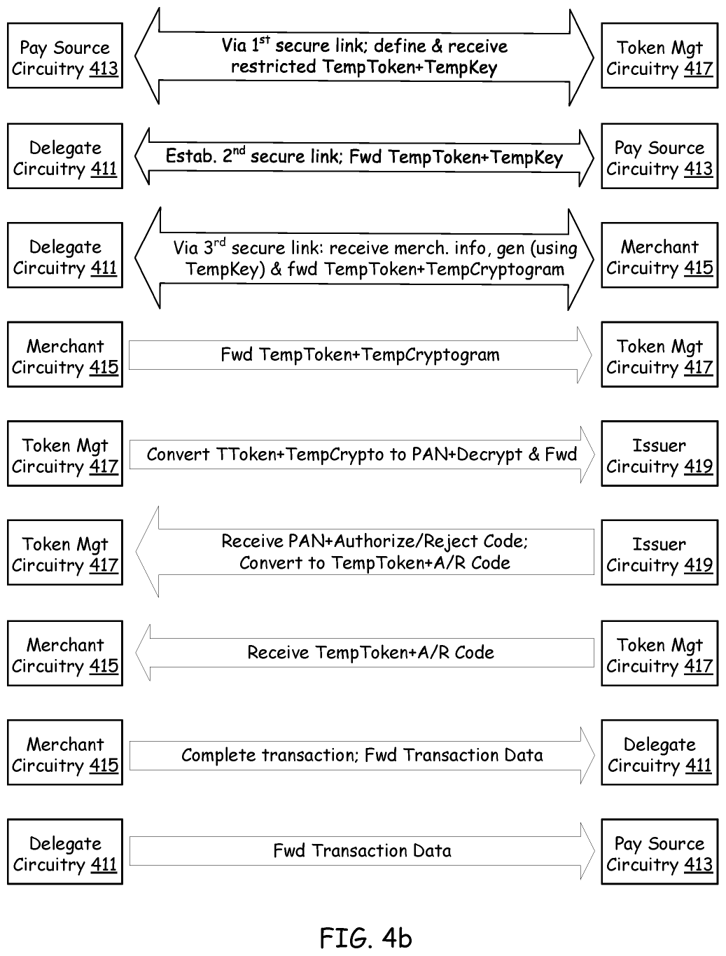

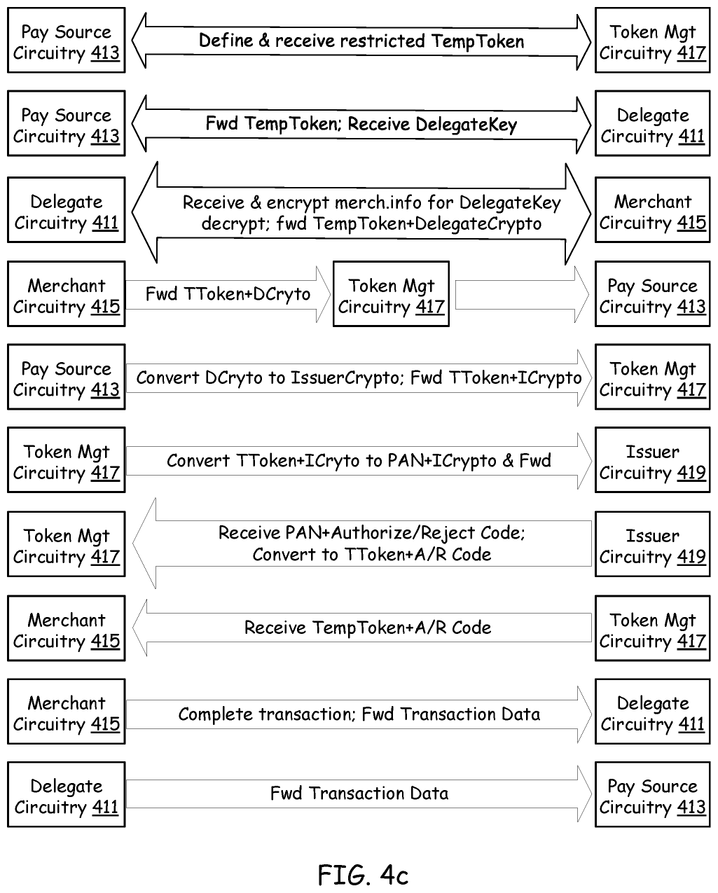

FIG. 4a illustrates flow of data and command between a plurality of devices and systems during a delegate-based sales transaction with a merchant web site or a merchant point of sale terminal, wherein a payer's payment device generates a cryptogram necessary for the delegate-based sales transaction. The payer's payment device comprising of a pay source circuitry 413 establishes a first secure communication link with a delegate circuitry 411. The first secure link is one of a wireless, wireline, Bluetooth, and a tethered link. The payer using the pay source circuitry 413 and a delegate using the delegate circuitry 411 chat, and/or share images, videos, and messages over the first secure link to select a plurality of products and/or services that the delegate purchases from the merchant POS using the delegate circuitry 411 on behalf of the payer. Once the payer and the delegate agree upon a list of products for purchase, the delegate circuitry 411 establishes a second secure communication link with the merchant POS comprising a merchant circuitry 415. The delegate circuitry 411 forwards the list of selected products to the merchant circuitry 415 over the second secure communication link. The merchant circuitry 415 in response sends merchant information to the delegate circuitry 411. The merchant information includes one or more of a, but not limited to, a merchant identifier, availability of the selected products, and transaction amount. The delegate circuitry 411 forwards the merchant information via the first secure communication link to the pay source circuitry 413 that either rejects or accepts the delegate-based sales transaction. If accepted, then the pay source circuitry 413 generates a cryptogram based on the merchant information and causes to deliver a delegate token and the cryptogram to the delegate circuitry 411. Delivery happens by either direct transmission from the pay source circuitry 413 to the delegate circuitry 411 via the first secure communication link or by indirect routing to the delegate circuitry 411 via a token management circuitry 417. The delegate circuitry 411 sends the delegate token and the cryptogram to the merchant circuitry 415 over the second secure communication link wherein the merchant circuitry 415 delivers the delegate token and the cryptogram to the token management circuitry 417. The token management circuitry 417 identifies the payer of the delegate-based sales transaction. It translates the delegate token to a PAN of the payer and sends the PAN and the cryptogram to the payer's card issuer circuitry 419. The issuer circuitry 419 decodes the cryptogram and based on the cryptogram sends an acceptance message or a rejection message to the token management circuitry 417. The token management circuitry 417 translates the payer's PAN to a token and sends the token and the acceptance/rejection message to the merchant circuitry 415. The merchant circuitry 415 upon receiving an acceptance message from the token management circuitry 417 completes the transaction and sends transaction data to the delegate circuitry 411. The delegate circuitry 411 forwards the transaction data to the pay source circuitry 413. A sales transaction with the merchant POS comprising the merchant circuitry 415 is thereby conducted by the delegate using the delegate circuitry 411 on behalf of the payer using the pay source circuitry 413.

FIG. 4b illustrates flow of data and command between a plurality of devices and systems during a delegate-based sales transaction with a merchant web site or a merchant point of sale terminal, wherein a delegate's payment device generates a cryptogram necessary for the delegate-based sales transaction. A pay source circuitry 413 used by the payer is communicatively coupled to a token management circuitry 417 over a first secure link that is one of a wired link, a wireless link or a tethered link. The token management circuitry 417 sends a temporary token and a temporary key to the pay source circuitry 413 via the first secure link in advance of the delegate-based sales transaction either in response to a request from the pay source circuitry 413 or be default. The temporary token as well as the temporary key are one or more of a limited time period, limited transaction amount, limited number of usage, merchant specific, channel specific, product specific. Restrictions on the temporary token and the temporary key are set by the token management circuitry 417 in consultation with the payer. The token management circuitry 417 generates the temporary token using PAN of the payer. The temporary key is generated by card issuer of the payer wherein the temporary key is delivered by the token management circuitry 417 from the card issuer to the pay source circuitry 413. The pay source circuitry 413 is communicatively coupled to a delegate circuitry 411 used by the delegate's payment device over a second secure link that is one of an NFC link, a low power Bluetooth link, a wired link, a wireless link or a tethered link. The pay source circuitry 413 forwards the temporary key and the temporary token to the delegate circuitry 411 over the second secure link. A list of products and/or services to be purchased by the delegate from the merchant POS comprising the merchant circuitry 415 is decided by the payer. The payer, in current configuration, arrives at such a decision based on chatting, or message exchange, or photo/video exchange between the pay source circuitry 413 and the delegate circuitry 411 via the second secure communication link in advance of the purchase. In the current configuration, the restrictions on the temporary key set by the token management circuitry 417 is based on the payer's decision regarding the list of products and/or services to be purchased by the delegate from the merchant circuitry 415 on behalf of the payer. In another configuration, the restrictions on the temporary key guides which products the delegate purchases from the merchant circuitry 415. In both of the configurations, the delegate circuitry 411 establishes a third secure communication link with the merchant circuitry 415 and initiates sales transaction by receiving merchant information from the merchant circuitry 415. The merchant information comprises of, for example, merchant identity, a list of products, their price. The delegate circuitry 411 generates a temporary cryptogram using the merchant information and sends the temporary token and the temporary cryptogram to the merchant circuitry 415 via the third secure link. The merchant circuitry 415 in turn forwards the temporary token and the temporary cryptogram to the token management circuitry 417 either directly or via an acquirer over a wireline/wireless communication link. The token management circuitry 417 converts the temporary token to the PAN of the payer using token2PAN and sends the PAN and the temporary cryptogram to card issuer of the payer wherein the card issuer uses a card issuer circuitry 419. The card issuer circuitry 419, in response, either rejects or accepts the delegate-based sales transaction and accordingly sends accept/rej ect message to the token management circuitry 417 that forwards the accept/rej ect message to the merchant circuitry 415. The merchant circuitry 415 upon receiving an acceptance message completes the transaction and sends transaction data to the delegate circuitry 411. The delegate circuitry 411 forwards the transaction data to the pay source circuitry 413. A sales transaction with the merchant POS wherein the delegate circuitry 411 generates the temporary cryptogram is thereby completed.

FIG. 4c illustrates flow of data and command between a plurality of devices and systems during a delegate-based sales transaction with a merchant web site or a merchant point of sale terminal, wherein a delegate's payment device generates a cryptogram necessary for the delegate-based sales transaction based on a delegate key generated by a payer's payment device. The payer's payment device comprises of a pay source circuitry 413, and the delegate's payment device comprises of a delegate circuitry 411. The pay source circuitry 413 receives a temporary token with restrictions which are one or more of a restriction on usage, restriction on choice of merchant, restriction on type of product, from a token management circuitry 417 via a first communication link. The restrictions are defined by the pay source circuitry 413. The pay source circuitry 413 generates the delegate key and sends the temporary token and the delegate key to the delegate circuitry 411 via a second communication link. In current configuration, the delegate key comprises of one or more of credentials of the delegate and delegate circuitry 411. The delegate circuitry 411 communicates with a merchant circuitry 415 over a third communication link and receives a merchant information from the merchant circuitry 415. The merchant information comprises of, but not limited to, merchant identity, price of products the delegate plans to purchase. The delegate circuitry 411 generates a delegate cryptogram based on the delegate key and the merchant information and sends the temporary token and the delegate cryptogram to the merchant circuitry 415. The merchant circuitry 415 forwards the temporary token and the delegate cryptogram to the token management circuitry 417 that forwards these data to the pay source circuitry 413. The pay source circuitry 413 decrypts the delegate cryptogram to get the merchant information, uses the merchant information to generate an issuer cryptogram, and sends the temporary token and the issuer cryptogram to the token management circuitry 417. The token management circuitry 417 converts the temporary token to PAN of the payer using Token2PAN, sends the PAN and the issuer cryptogram to an issuer circuitry 419 that is used by the payer's card issuer. The card issuer circuitry 419 either accepts or rejects the sales transaction. If accepted, the merchant circuitry 415 completes the sales transaction, and informs the delegate circuitry 411 about the same. The delegate circuitry 411 in turn informs the pay source circuitry 413.

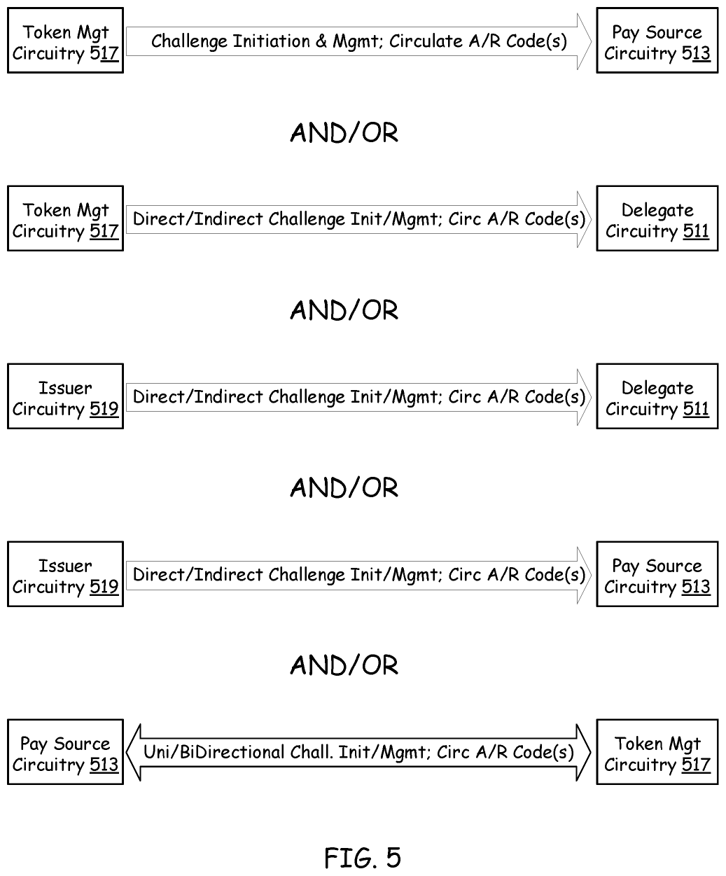

FIG. 5 illustrates flow of challenges between a plurality of devices and systems during a delegate-based sales transaction wherein a delegate performs the sales transaction with a merchant POS or a merchant website on behalf of a payer. In one configuration, the payer's payment device using a pay source circuitry 513 delivers a delegate token issued by a token management circuitry 517 to the delegate's device. The delegate's device conducts a sales transaction with a merchant POS or online using the delegate token. During the sales transaction the delegate token reaches the token management circuitry 517 which figures out that the delegate is conducting the sales transaction on behalf of the payer. The token management circuitry 517 issues a first challenge to the pay source circuitry 513 used by the payer. The first challenge includes, for example, the payer's credentials. The pay source circuitry 513 replies to the first challenge, and the token management circuitry 517 issues a transaction acceptance or rejection notice in response to the reply. In a second configuration the token management circuitry 517 issues a second challenge to a delegate circuitry 511 used by the delegate. The second challenge includes, for example, the delegate's credentials and the delegate circuity authentication. The token management circuitry 517 either sends the second challenge directly to the delegate circuitry 511 or gets the second challenge delivered to the delegate circuitry 511 via the pay source circuitry 513 or via merchant POS or via another token management system with which the delegate circuitry 511 is registered. The delegate circuitry 511 responds to the second challenge and the token management circuitry 517 circulates transaction acceptance or rejection notice in response to reply from the delegate circuitry 511. In a third configuration a card issuer using a card issuer circuitry 519 issues a third challenge to the delegate circuitry 511. The card issuer circuitry 519 gets the third challenge delivered to the delegate circuitry 511 via the token management circuitry 517 or the pay source circuitry 513 or via another token management system with which the delegate circuitry 511 is registered. The third challenge includes, for example, and without limitation, delegate device authentication, delegate credential verification. In yet another configuration the card issuer circuitry 519 sends a fourth challenge to the pay source circuitry 513.

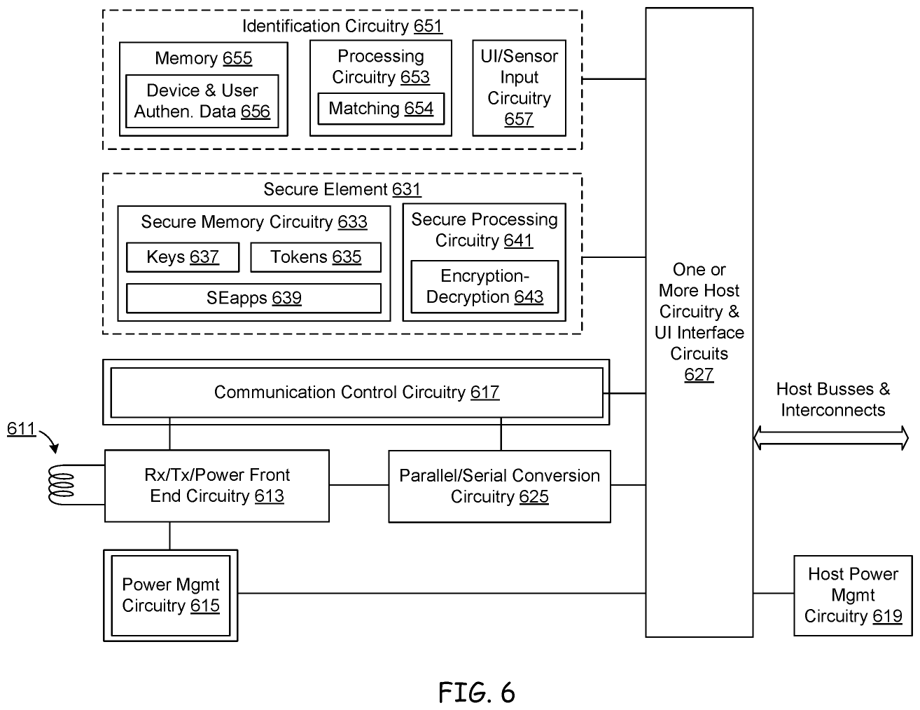

FIG. 6 is a perspective block diagram of a plurality of circuitry involved in a delegate-based sales transaction with a merchant web site or a merchant point of sale terminal. The plurality of circuitry is present in a payment device that is used by either a payer or a delegate during the delegate-based sales transaction. The payment device comprises of a host circuitry and a user interface circuitry 627. Applications that cause the payment device to conduct sales transactions with a merchant system directly run on the circuitry 627. The merchant system is either a merchant website or a merchant point of sale terminal. The applications are for example and without limitation, a host card emulation application, a digital payment application like Apple Pay or Google Wallet. The payment device in addition comprises of a power management circuitry 615 that regulates power drawn by the plurality of circuitry from a battery on the payment device in order to minimize total power usage. The power management circuitry 615 draws power from a host power management circuitry 619 via the user interface circuitry 617 in the event of “battery down”. The payment device comprises of rx/tx/power front end circuitry 613, communication control circuitry 617 and parallel-serial conversion circuitry 625. The payment device comprises of an identification circuitry 651. The identification circuitry 651 comes in use for establishment of identity of the payment device and authenticity of a user using the payment device during sales transactions with the merchant system, the sales transaction being a direct or a delegate-based sales transaction. The identification and authentication process involve, for example and without limitation, identification using biometrics, PIN, and device profile. The identification circuitry 651 comprises of processing circuitry 653 that looks for matching between user and device authentication data 656 saved in a memory 655 with data entered by the user using the user interface circuitry 657. If the saved data matches with the data entered, then the sales transaction proceeds, otherwise gets rejected. The sales transaction with the merchant system using the payment device happens by way of using tokens, and cryptograms instead of using PAN of the user. The payment device comprises of a secure element 631 that stores tokens 635 and keys 637 used during the direct and/or delegate-based sales transaction with the merchant system. The secure element 631 has a secure processing circuitry 641 that generates cryptogram based on merchant data and token and decrypts cryptogram to get the merchant data and token back. During the direct sales transaction with the merchant system, a direct token and a cryptogram are sent by the payment device to the merchant system that the merchant system uses to sell the products and bill the payer. During the delegate-based sales transaction a delegate token and a cryptogram are sent by the payment device used by the payer to a second payment device used by the delegate wherein the second payment device uses the delegate token and the cryptogram to purchase goods and/or services from the merchant system. A secure application 639 that controls and manages all steps of the delegate-based sales transaction is stored and runs from the secure circuitry 633.

As one of ordinary skill in the art will appreciate, the term “payment processing infrastructure” incorporates card issuer systems, card payment networks, etc. For example, payment processing infrastructure is a combination of 1^{st} token management system 131, 2^{nd} token management system 141, 1^{st} account issuer system 151, 2^{nd} account issuer system 161, or a subset of such a combination.

As one of ordinary skill in the art will appreciate, the term “processing circuitry” of a mobile device or phone device includes a processor (microprocessor for example), memory (NAND or NOR DRAMS, SSD etc.), and even a secure element in some configurations. For example, processing circuitry comprises the host processing & memory circuitry 211, and even the secure circuitry 231 in some configurations.

As one of ordinary skill in the art will appreciate, the processing circuitry that is configured to pass token and encryption information to secure at least part of the transaction data employs encryption/decryption techniques. Such techniques are supported / made available by a secure element in the mobile devices/phone devices. For example, the first cellular phone of 211 of a remote user provides encryption features, wherein the encryption involves transaction cryptograms. For example, the processing circuitry 211 employs the secure circuitry 231 that is capable of tokenization, cryptogram processing, encryption, decryption and secure transactions.

As one of ordinary skill in the art will appreciate, the terms “merchant terminal” includes point-of-sale devices used in most stores and commercial establishments, computing devices that keep track of sales receipts and sales transactions, counter-top electronic devices used for ad hoc sales, iPad and tablet-based systems such as those that employ credit card processing accessories provided by companies such as Square systems, etc.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

Although the present invention has been described in terms of GPS coordinates/and navigational information communication involving mobile phones and computers, it must be clear that the present invention also applies to other types of devices including mobile devices, laptops with a browser, a hand-held device such as a PDA, a television, a set-top-box, a media center at home, robots, robotic devices, vehicles capable of navigation, and a computer communicatively coupled to the network.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A first cellular phone of a first person, the first cellular phone supporting a purchase transaction involving a merchant terminal of a merchant and a payment processing infrastructure, the purchase transaction occurring while the merchant terminal and the first cellular phone are collocated a first premises, the first cellular phone comprising:
first communication circuitry configured to couple via cellular telephony networks to a second cellular phone of a second person, the second person being a buyer, the first person being independent of the merchant and assisting the buyer in the purchase transaction;
second communication circuitry configured to couple with the merchant terminal; and
processing circuitry configured to securely manage the purchase transaction carried out between the second cellular phone and the merchant terminal based on token and cryptogram exchanges via the first communication circuitry and the second communication circuitry, while the second cellular phone is at a location remote from the first premises.

2. The first cellular phone of claim 1, wherein, during the purchase transaction, the processing circuitry is configured to enable communication between the first person and the second person during the purchase transaction.

3. The first cellular phone of claim 1, wherein the processing circuitry is configured to exchange encrypted pin code information between the second cellular phone via the merchant terminal.

4. The first cellular phone of claim 3, wherein the encrypted pin code information is for a one time use.

5. The first cellular phone of claim 1, wherein the purchase transaction is a card based transaction involving an issuer.

6. The first cellular phone of claim 5, wherein the processing circuitry is configured to pass token and encryption information to secure at least part of purchase transaction data from access by the first person.

7. The first cellular phone of claim 6, wherein the encryption involves transaction cryptograms.

8. A computing device of a first person, the first person being a buyer, the computing device interacting to carry out a purchase transaction with a merchant terminal that interacts with a payment processing infrastructure, the computing device comprising:
communication circuitry configured to couple with a cellular phone of a second person, the cellular phone being collocated with the merchant terminal at a first premises during the purchase transaction, the computing device and the first person being at a location remote from the first premises; and
processing circuitry configured to securely manage the purchase transaction carried out with the merchant terminal through the cellular phone of the second person via the communication circuitry.

9. The computing device of claim 8, which comprises a cellular device of the first person.

10. The computing device of claim 8, wherein the processing circuitry supports interaction with the payment processing infrastructure to assist in confirming the purchase transaction.

11. The computing device of claim 8, wherein, during the purchase transaction, the processing circuitry is configured to enable communication between the first person and the second person during the purchase transaction.

12. The computing device of claim 8, wherein the processing circuitry is configured to exchange encrypted pin code information between the cellular phone of the second person via the merchant terminal.

13. The computing device of claim 8, wherein the purchase transaction is a card based transaction involving an issuer.

14. A method performed by a support device of a buyer's assistant to assist a buyer device of a buyer in carrying out a purchase transaction between the buyer device and a merchant system, the merchant system being coupled to a transaction processing infrastructure, the transaction processing infrastructure including an issuer system of an issuer, the method comprising:
establishing a first secure communication flow with the buyer device;
establishing a second secure communication flow with the merchant system; and
managing the purchase transaction using a secure element within the support device to attempt to prevent revelation of private transaction information of the buyer, and utilizing a limited usage element to carry out a present transaction for a remote buyer.

15. The method of claim 14, wherein the support device and the merchant system are located at a first premises during the purchase transaction.

16. The method of claim 14, wherein the merchant system is located at a first premises and the buyer device is at a location outside of the first premises.

17. The method of claim 14, wherein the support device is a cellular phone device.

18. The method of claim 14, wherein the buyer device is a cellular phone device.

19. The method of claim 14, wherein the merchant system comprises an online server system accessible via an Internet.

20. The method of claim 14, wherein the merchant system comprises a point of sale device.
